(19) United States
(12) Patent Application Publication
(10) Pub. No.: US 2004/0253376 A1
(43) Pub. Date: Dec. 16, 2004

(54) Fabric treatment compositions

(76) Inventor: Andrew Philip Parker, Wirral (GB)

Correspondence Address: UNILEVER, PATENT DEPARTMENT, 45 RIVER ROAD, EDGEWATER, NJ, 07020, US

(21) Appl. No.: 10/492,288

(22) PCT Filed: Sep. 26, 2002
(86) PCT No.: PCT/EP02/10756

(30) Foreign Application Priority Data
Oct. 11, 2001 (GB) 01244565

(51) Int. Cl. B05D 3/12

(52) U.S. Cl. 427/242

(57) ABSTRACT

The invention relates to a fabric treatment composition for use in a tumble dryer where the benefit agent(s) is/are contained within a rigid outer shell. A first aspect of the present invention provides a dispenser comprising a rigid and fragile outer shell and containing a benefit agent, together with instructions to use the same in the tumble dryer. A second aspect of the present invention provides for a method of fabric treatment which comprises the steps of: a) placing the fabric, together with a dispenser in a tumble-drier, and, b) operating the tumble drier, wherein the dispenser comprises a rigid and fragile outer shell and contains a benefit agent. The benefit agent contained within the shell can be in a powder, gel or liquid form, such that when the outer shell breaks, the agents are released to deposit onto the fabric, thus imparting the required benefit. It is believed that a shell which fragments to a fine powder enables the rapid release and dispersal of the benefit agent. The powder produced is sufficiently fine to be lost through the drum of the dryer.

### FIELD OF THE INVENTION

This invention relates to a fabric treatment composition for use in a tumble dryer where the benefit agent(s) is/are comprised and preferably contained within a rigid outer shell.

### BACKGROUND AND PRIOR ART

‘Unit dose’ means of delivery for detergent compositions useful in home laundry have been known for many years. Early products of this type included sachets which opened in the wash. These have the disadvantage that the sachet must be recovered at the end of the wash. More recently tablets and water-soluble sachets have provided means for delivering detergents without the need for recovery of some component.

Some forms of laundry tablet use various disintegrant materials which either swell on contact with water or dissolve rapidly. It is also known to form tablets from a loosely sintered material and then coat the tablet with a dicarboxylic acid based material to provide some structural integrity. For tablets which are delivered via the drum (as opposed to drawer dispensed) it is known to use a net-like bag to prevent the tablet staying in one place and producing a prolonged contact between the tablet and the fabrics being washed.

Numerous patents describe various fabric treatments applied in the tumble dryer. One of the obvious differences between the washing environment and the drying environment is that far less water is present in the drying environment. A consequence of this is that it is difficult to ensure uniform distribution of whatever treatment agent is being applied. Several approaches have been made to this problem. The methods of delivery mentioned in the literature are: aerosol foams, structured foams, dispensers, and flexible sheets.

U.S. Pat. No. 3,796,599, U.S. Pat. No. 4,077,891, U.S. Pat. No. 3,650,816, EP 0839905, U.S. Pat. No. 3,806,359, U.S. Pat. No. 3,963,629, U.S. Pat. No. 3,822,145, U.S. Pat. No. 3,826,682, U.S. Pat. No. 4,242,377, U.S. Pat. No. 4,252,656 describe the application of various treatments in the tumble dryer dispensed as a foam. Patent WO 0024851 describes a fabric care composition applied to fabric by either spraying, soaking, dipping or during the pre-wash or rinse stage of the laundry process. The composition is preferably added as a spray in the dryer.

U.S. Pat. No. 1,357,740 and U.S. Pat. No. 1,357,739 describe the use of an aerosol spray by which agents are applied to the drum of the dryer.

Dryer sheets appear to be, in practice, the most commercially widespread vehicles for delivery. These suffer from the disadvantage that they must be recovered at the end of the dryer cycle.

U.S. Pat. No. 5,869,442 and WO 9411482 describes the use of DTI (dye-transfer inhibition) polymers (such as PVP) in the rinse stage of the washing process or the drying stage using dryer sheet form as a dryer delivery method. U.S. Pat. No. 1,571,527 describes the use of a impregnated sheet to deliver cationic softener during the drying stage. Patent WO 9840459 describes the dryer-activated laundry additive compositions with colour care agents from a dryer sheet. U.S. Pat. No. 1,571,526 describes the delivery of polyglycerol esters in the dryer from a flexible sheet. Patent WO 9812296 describes the delivery of dye fixing agents from a sheet. Patent WO 9841605 describes an improved fabric care composition comprising a pro-perfume and an amino-functional polymer delivered from a substrate, preferably a sheet.

WO94/11482 discloses a “vanishing substrate material” mentioned, but no detail is given on what this substrate is.

Many proposals have been made which relate to dispensers comprising a rigid outer shell, usually formed of a plastics material. In addition to the obvious problems of noise in the dryer, certain difficulties have also been encountered in providing plastics material dispensers which can survive the temperatures encountered in the dryer cycle without melting or other damage. WO 0015755 describes a fabric care composition comprising a amine- or amide-epichlorohydrin resin or derivative, delivered from a sheet or sponge or a dispenser such as a dosing ball. These devices have the disadvantage that they must be recovered at the end of the dryer cycle.

### BRIEF DESCRIPTIONS OF THE INVENTION

We have determined that the above mentioned problems are overcome by a rigid dispenser which is shattered to a fine powder by the action of the tumble dryer.

Accordingly, a first aspect of the present invention provides a dispenser comprising a rigid and fragile outer shell and further comprising a benefit agent, together with instructions to use the same in the tumble dryer.

A second aspect of the present invention provides for a method of fabric treatment which comprises the steps of:

a) placing the fabric, together with a dispenser in a tumble-drier, and,

b) operating the tumble drier,

wherein the dispenser comprises a rigid and fragile outer shell and further comprises a benefit agent,

The benefit agent is preferably enclosed within the shell of the dispenser. The benefit agent can be can be in a powder, gel or liquid form, such that when the outer shell breaks, the agents are released to deposit onto the fabric, thus imparting the required benefit. In an alternative embodiment the benefit agent can be comprised within the material of the shell itself.

It is believed that a shell which fragments to a fine powder enables the rapid release and dispersal of the benefit agent.

The powder produced is sufficiently fine to be lost through the drum of the dryer. However it is advantageous that the powder should not give adverse effects if it remains on the articles being washed.

Advantageously, there is no need to recover any component of the dispenser (such as a net, ball or dryer sheet) at the end of the drying cycle.

### DETAILED DESCRIPTION OF THE INVENTION

Shell Materials:

In preferred forms of the invention, the outer shell comprises one or more biodegradable non-hazardous materials. It is preferable that at least one of these materials has melting points above 35° C. and has adequate mechanical robustness. Preferably the robustness is such that when melt-formed the shell can withstand a weight of at least 500 g. As noted above, at least some of the components used to form the shell may be benefit agents themselves.

Preferably the shell is a sphere. This has the advantage that the quantity of shell required material is minimised for a given internal volume.

Suitable shell materials comprise mixtures of:

a) cellulosic materials, and

b) polyol esters.

Suitable cellulosic materials include hydroxyalkyl cellulose materials and fibrous cellulose materials.

Suitable esters include glycol and glyceryl esters and in particular stearates thereof.

It is believed that quantities of both of these preferred materials may become deposited on the articles being washed without detriment.

Optionally, the shell material comprises perfume.

The shell can be moulded from a suitable material. Preferably the shell is cast. Where the shell is a sphere it is preferable to cast the shell in the form of two hemispheres which are fixed together.

Benefit Agents:

Benefit agents may be selected from the following: fabric softeners, perfumes, colour enhancers, optical brightening agents, antimicrobial agents, pill/fuzz prevention agents, dye transfer inhibitors, soil release agents, anti-redeposition agents, fibre lubricants, sequestrants, odour elimination agent.

If the composition of the present invention is in the form of a textile conditioner composition, the benefit agent will comprise a textile softening and/or conditioning compound (hereinafter referred to as “textile softening compound”), which may be a cationic or nonionic compound.

The softening and/or conditioning compounds are preferably water insoluble quaternary ammonium compounds, sugar derivatives or mixtures of the same.

Suitable cationic textile softening compounds are substantially water-insoluble quaternary ammonium materials comprising a single alkyl or alkenyl long chain having an average chain length greater than or equal to C₂₀. More preferably, softening compounds comprise a polar head group and two alkyl or alkenyl chains having an average chain length greater than or equal to C₁₄. Preferably the textile softening compounds have two, long-chain, alkyl or alkenyl chains each having an average chain length greater than or equal to C₁₆.

Most preferably at least 50% of the long chain alkyl or alkenyl groups have a chain length of C₁₈ or above. It is preferred if the long chain alkyl or alkenyl groups of the textile softening compound are predominantly linear.

Quaternary ammonium compounds having two long-chain aliphatic groups, for example, distearyldimethyl ammonium chloride and di(hardened tallow alkyl) dimethyl ammonium chloride, are widely used in commercially available rinse conditioner compositions. Other examples of these cationic compounds are to be found in “Surface-Active Agents and Detergents”, Volumes I and II, by Schwartz, Perry and Berch. Any of the conventional types of such compounds may be used in the compositions of the present invention.

The textile softening compounds are preferably compounds that provide excellent softening, and are characterised by a chain melting Lβ to Lα transition temperature greater than 25° C., preferably greater than 35° C., most preferably greater than 45° C. This Lβ to Lα transition can be measured by DSC as defined in “Handbook of Lipid Bilayers”, D Marsh, CRC Press, Boca Raton, Fla., 1990 (pages 137 and 337).

Substantially water-insoluble textile softening compounds are defined as textile softening compounds having a solubility of less than 1×10⁻³ wt % in demineralised water at 20° C. Preferably the textile softening compounds have a solubility of less than 1×10⁻⁴ wt %, more preferably less than 1×10⁻⁸ to 1×10⁻⁶ wt %.

Especially preferred are cationic textile softening compounds that are water-insoluble quaternary ammonium materials having two C₁₂₋₂₂ alkyl or alkenyl groups connected to the molecule via at least one ester link, preferably two ester links. An especially preferred ester-linked quaternary ammonium material can be represented by the formula:

N⁺R₁.R₁.(R₃-T-R₂).(CH₂)ₚ-T-R₂

wherein each R₁ group is independently selected from C₁₋₄ alkyl or hydroxy-alkyl groups or C₂₋₄ alkenyl groups; each R₂ group is independently selected from C₈₋₂₈ alkyl or alkenyl groups; and wherein R₃ is a linear or branched alkylene group of 1 to 5 carbon atoms, T is an ester linkage in either orientation, i.e.

—O—CO— or —CO—O—;

and p is 0 or is an integer from 1 to 5.

Di(tallowoxyloxyethyl) dimethyl ammonium chloride and/or its hardened tallow analogue is especially preferred.

A second preferred type of quaternary ammonium material can be represented by the formula:

(R₁)₃N⁺—(CH₂)ₚ.CH.(TR2)(CH₂TR₂)

wherein R₁, p, T and R₂ are as defined above.

It is advantageous if the quaternary ammonium material is biologically biodegradable.

Preferred materials of this class such as 1,2-bis(hardened tallowoyloxy)-3-trimethylammonium propane chloride and their methods of preparation are, for example, described in U.S. Pat. No. 4,137,180 (Lever Brothers Co). Preferably these materials comprise small amounts of the corresponding monoester as described in U.S. Pat. No. 4,137,180, for example, 1-hardened tallowoyloxy-2-hydroxy-3-trimethyl-ammonium propane chloride.

Other useful cationic softening agents are alkyl pyridinium salts and substituted imidazoline species. Also useful are primary, secondary and tertiary amines and the condensation products of fatty acids with alkylpolyamines.

The compositions may alternatively or additionally contain water-soluble cationic textile softeners, as described in GB 2 039 556B (Unilever).

The compositions may comprise a cationic textile softening compound and an oil, for example as disclosed in EP-A-0829531.

The compositions may alternatively or additionally contain nonionic textile softening agents such as lanolin and derivatives thereof.

Lecithins are also suitable softening compounds.

Nonionic softeners include Lβ phase forming sugar esters (as described in M Hato et al Langmuir 12, 1659, 1666, (1996)) and related materials such as glycerol monostearate or sorbitan esters. Often these materials are used in conjunction with cationic materials to assist deposition (see, for example, GB 2 202 244). Silicones are used in a similar way as a co-softener with a cationic softener in rinse treatments (see, for example, GB 1 549 180).

The composition can also contain fatty acids, for example C₈ to C₂₄ alkyl or alkenyl monocarboxylic acids or polymers thereof. Preferably saturated fatty acids are used, in particular, hardened tallow C₁₆ to C₁₈ fatty acids. Preferably the fatty acid is non-saponified, more preferably the fatty acid is free, for example oleic acid, lauric acid or tallow fatty acid. The weight ratio of quaternary ammonium material or other cationic softening agent to fatty acid material is preferably from 10:1 to 1:10.

Sugar derivatives are also suitable softening agents.

The preferred sugar derivatives are solid (at room temperature of 20 C) derivatives of a cyclic polyol or of a reduced saccharide, said derivatives resulting from at least one, and preferably two or more of the hydroxyl groups in said polyol or in said saccharide being esterified or etherified. Preferably, the derivatives have two or more ester or ether groups independently attached to a C₈-C₂₂ alkyl or alkenyl chain.

Examples of suitable saccharides include xylose, arabinose, galactose, fructose, sorbose and glucose. Glucose is especially preferred. An example of a reduced saccharide is sorbitan. Examples of suitable disaccharides include maltose, lactose, cellobiose and sucrose. Sucrose is especially preferred.

In order that the invention may be further and better understood it will be described hereinafter with reference to examples.

### EXAMPLES:

### Example 1

A hollow sphere of 25 mm external diameter, 23 mm internal diameter, was produced from a mix of 42% Cellosize QP-100 MH (hydroxyethylcellulose, Union Carbide) and 58% Tegin G (glycol stearate SE, Goldschmidt). The ester was heated above its melting point whereupon the hydroxyethylcellulose was blended in to form a low viscosity paste. A small quantity of perfume was added. The physical properties of the shell were such that under drying conditions the shell rapidly broke up without forming sticky residues either in the dryer or in the dryer filter. No spotting was observed on the treated fabrics.

The molten material was then poured into a hemispherical mould and formed into a hemisphere of 1 mm thickness. Two identical shells were then bonded together by the application of heat to the edges.

The softening composition comprised a 2:1 mix of Sisterna SP-50C (sucrose polyester, Sisterna) and Tegin 4100 (glyceryl stearate, Goldschmidt). The two materials were mixed together, heated to above the melting point of the sucrose polyester, then allowed to solidify. The resulting material was then ground to a powder. Addition of the ester is necessary to reduce the viscosity of molten sucrose polyester so that even deposition is achieved.

The powdered material was then introduced through a hole in the shell of the sphere. When the requisite amount had been added, the hole was filled with molten material as detailed above.

The above sphere was added to a 2 kg mixed load of woven cotton sheeting, terry towelling and blue cotton interlock. After sixty minutes drying, the load was removed and panelled in comparison with an untreated load and one treated with a tumble-dryer sheet.

On completion of the drying cycle, the treated fabric was found be softer than the untreated and perfumed.

### Example 2

A hollow sphere of 25 mm external diameter, 23 mm internal diameter, was produced from a mix of 40% Arbocel B600 (fibrous cellulose, 60 μm average fibre length, 20 μm average fibre thickness, J Rettenmaier) and 60% Tegin G (glyceryl stearate SE, Goldschmidt).

The ester was heated above it's melting point whereupon the hydroxyethylcellulose was blended in to form a low viscosity paste. A small quantity of perfume was added. The physical properties of the shell were such that under drying conditions the shell rapidly broke up without forming sticky residues either in the dryer or in the dryer filter. No spotting was observed on the treated fabrics.

The interior was filled with a 2:1 mix of Sisterna SP-50C (sucrose polyester, Sisterna) and Tegin 4100 (glyceryl stearate, Goldschmidt). The two materials were mixed together, heated to above the melting point of the sucrose polyester, then allowed to solidify. The resulting material was then ground to a powder. Addition of the ester is necessary to reduce the viscosity of molten sucrose polyester so that even deposition is achieved.

The above sphere was added to a 2 kg mixed load of woven cotton sheeting, terry towelling and blue cotton interlock. After sixty minutes drying, the load was removed and panelled in comparison with an untreated load and one treated with a tumble-dryer sheet.

On completion of the drying cycle, the treated fabric was found be softer than the untreated and perfumed.

### Example 3

A hollow sphere of 25 mm external diameter, 23 mm internal diameter, was produced from a mix of 40% Arbocel B600 (fibrous cellulose, 60 μm average fibre length, 20 μm average fibre thickness, J Rettenmaier) and 60% Tegin G (glyceryl stearate SE, Goldschmidt).

The ester was heated above it's melting point whereupon the hydroxyethylcellulose was blended in to form a low viscosity paste. A small quantity of perfume was added. The physical properties of the shell were such that under drying conditions the shell rapidly broke up without forming sticky residues either in the dryer or in the dryer filter. No spotting was observed on the treated fabrics.

The interior was filled with a 2:1 mix of Sisterna SP-50C (sucrose polyester, Sisterna) and Tegin 4100 (glyceryl stearate, Goldschmidt). The two materials were mixed together, heated to above the melting point of the sucrose polyester, then allowed to solidify. The resulting material was then ground to a powder. Addition of the ester is necessary to reduce the viscosity of molten sucrose polyester so that even deposition is achieved. A further addition of 0.2 g of poly(vinyl pyrrolidone), molecular weight 40,000, was added to impart next-wash dye-transfer benefits.

To test the dye-transfer benefit, 1 kg of the treated woven cotton was washed at 40° C. with 35 g of Persil Original Non-Biological washing powder in a Whirlpool horizontal axis washing machine containing 80 g. of unfixed Direct Green 26 woven cotton. A similar wash was carried out using 1 kg of untreated woven cotton. The degree of dye transfer was measured using a Datacolor International Microflash 200d spectrophotometer.

Untreated cloth ΔE 14.62 (std. devn. 0.59)

Treated cloth ΔE 11.92 (std. devn. 0.21)

The cloth treated with the dryer ball has reduced dye transfer, signified by the lower AE value measured on the cloth.

1. A dispenser comprising a single rigid and fragile outer shell and containing a benefit agent, together with instructions to use the same in the tumble dryer, wherein in use, the shell fragments into a powder which is sufficiently fine to be lost through the drum of the dryer.

2. A dispenser according to claim 1 comprising a benefit agent in powder form.

3. A dispenser according to claim 1 wherein the shell comprises a material having a melting point above 35° C.

4. A dispenser according to claim 1 having sufficient mechanical robustness when melt-formed to support a weight of at least 500 g.

5. A dispenser according to claim 1, wherein the shell comprises a mixture of cellulosic materials and polyol esters.

6. A dispenser according to claim 5, wherein the cellulosic material includes one or both of hydroxy-alkyl cellulose materials and fibrous cellulose materials.

7. A dispenser according to claim 5, wherein the polyol ester includes one or both of glycol and glyceryl esters.

8. A dispenser according to claim 1 wherein shell material also comprises perfume.

9. A dispenser according to claim 1 wherein the shell is cast.

10. A dispenser according to claim 1 wherein the benefit agent comprises a solid sugar ester.

11. A method of fabric treatment which comprises the steps of:
(a) placing the fabric, together with a dispenser according to claim 1 in a tumble-drier, and
(b) operating the tumble drier.
